(19) United States
(12) Patent Application Publication
(10) Pub. No.: US 2019/0211621 A1
(43) Pub. Date: Jul. 11, 2019

(54) WINDOW COVERING FOR AN ARCHED WINDOW

(71) Applicant: Lafayette Venetian Blind, Inc., West Lafayette, IN (US)

(72) Inventors: Joe Nash Morgan, III, West Lafayette, IN (US); Brad King, West Lafayette, IN (US); John W. Click, Lafayette, IN (US); Adam J. Vandewalle, Lafayette, IN (US)

(21) Appl. No.: 16/239,939

(22) Filed: Jan. 4, 2019

Related U.S. Application Data
(60) Provisional application No. 62/613,909, filed on Jan. 5, 2018.

(51) Int. Cl. E06B 9/264; E06B 9/302

(52) U.S. Cl. CPC E06B 9/264; E06B 2009/2452; E06B 9/302

(57) ABSTRACT

Window covering assemblies having a housing supporting a first panel and having a second, movable panel are disclosed. The movable panel can have a frame positioned within the housing. The first and second panels can comprise alternating portions of different opacity and/or polarization. The assemblies include a drive assembly that is driven by a motor to move the movable panel relative to the first panel. As the movable panel moves with respect to the second panel, the alignment of the slats for each the panels changes, varying the amount of visible light that is allowed through the assembly.

### BACKGROUND

The present disclosure pertains generally to window coverings. Window coverings, such as blinds, shades, transitional shades, and shutters, are used to adjust the amount of visible light that passes through a window.

Many existing window coverings are adjusted manually, for example by an actuating member such as a pull cord. However, for windows that are large and/or out-of-reach, the lengths of these actuating members can become excessive and unsightly. Additionally, pull cords can present a safety hazard to small children.

Non-rectangular windows also present challenges to certain window coverings. As slats for window coverings, such as shutters, in many instances extend horizontally or vertically across the window, non-rectangular windows (e.g., arched windows) require slats of varying length in order for the window covering to match the profile of the window. Manufacturing such coverings can be challenging, and costly, due to the increased number and complexity of different parts.

While many different window coverings are available, there remains a need for systems that are simple, reliable, easy-to-use, and affordable.

### SUMMARY

The present disclosure pertains generally to window coverings. In certain aspects, the present disclosure provides assemblies, such as transitional shade assemblies, including a second panel movable relative to a first panel so as to align and/or offset non-opaque portions of the first and second panels. In at least one arrangement, a transitional shade assembly comprises: a housing defining a first opening; a first panel attached to the housing and extending across the first opening, the first panel having a first non-opaque portion; a frame defining a second opening, the second opening facing the first opening; a second panel attaching to the frame and extending across the second opening, the second panel having a first non-opaque portion; and a drive assembly coupled to the frame and configured to move the frame from a first position to a second position relative to the housing; wherein in the first position the first non-opaque portion of the second panel is aligned with the first non-opaque portion of the first panel; and wherein in the second position the first non-opaque portion of the second panel is offset from the first non-opaque portion of the first panel.

In some arrangements, a transitional shade assembly comprises: a housing defining a first opening; a first panel attached to the housing and extending across the first opening, the first panel having a first non-opaque portion; and a second panel overlapping the first panel and coupled to a drive assembly configured to move the second panel from a first position to a second position relative to the first panel, the second panel having a first non-opaque portion; wherein the drive assembly is arranged to push the second panel upwards against the force of gravity to move the second panel from the first position to the second position; wherein in the first position the first non-opaque portion of the second panel is aligned with the first non-opaque portion of the first panel; and wherein in the second position the first non-opaque portion of the second panel is offset from the first non-opaque portion of the first panel.

The drive assembly can be configured to translationally move the frame and/or second panel along a first direction from the first position to the second position. The frame can extend along an edge of the second panel in the first direction. The frame defining the second opening can extend partially or completely around the perimeter of the second opening.

The drive assembly can include a motor coupled to a bottom portion of the frame and arranged to push the frame upwards against the force of gravity. The motor may move with the frame from the first position to the second position.

The first and/or second panels can include at least two slats wherein at least one of the slats is more opaque than at least one other slat.

The frame can be positioned within the housing.

The drive assembly can include a driveshaft extending from the motor and having a pinion gear engaging a gear rack, wherein the frame and/or first panel are/is moveable relative to the gear rack.

The second panel can be a different size than the first panel. Preferably, the second panel is larger than the first opening.

In the embodiment shown, the assembly has an arched shape to fit within an arched window. For example, an upper end of the housing can be arched to correspond with an arched window. However, different embodiments may have portions having different shapes to fit different styles of windows. For example, the assembly may be partially or entirely octagonal, hexagonal, rectangular, or triangular, just to name a few non-limiting examples.

The “panels” disclosed herein, unless otherwise specified, may be rigid or flexible. For example, the panels may comprise a flexible sheet. The panel may include portions having different opacity. For example, a first slat may be more opaque than another slat. It is contemplated, the panels may comprise polarized portions that are movable into or out of alignment to block more or less visible light.

The term “Non-opaque” as used herein means translucent and/or transparent.

The term “window covering” as used herein includes blinds, shades, transitional shades, and shutters.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a rear perspective view of a window covering assembly.

FIG. 2 is a perspective view of a housing of the assembly of FIG. 1.

FIG. 3 is a front view of a first portion of the housing of FIG. 2.

FIG. 4 is a rear view of a movable panel of the assembly of FIG. 1.

FIG. 5 is a perspective view of a portion of a drive assembly of movable panel of FIG. 4.

FIG. 6 is a rear view of a panel and a second portion of the housing of FIG. 1.

FIG. 7 is an exploded view of the assembly of FIG. 1.

FIG. 8 is a diagram showing a panel configuration for blocking visible light through the assembly of FIG. 1.

FIG. 9 is a diagram showing allowed panel configuration for allowing visible light through the assembly of FIG. 1.

FIG. 10 is a rear view of the assembly of FIG. 1 with the movable panel of FIG. 4 in a first position.

FIG. 11 is a rear view of the assembly of FIG. 1 with the movable panel of FIG. 4 in a second position.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

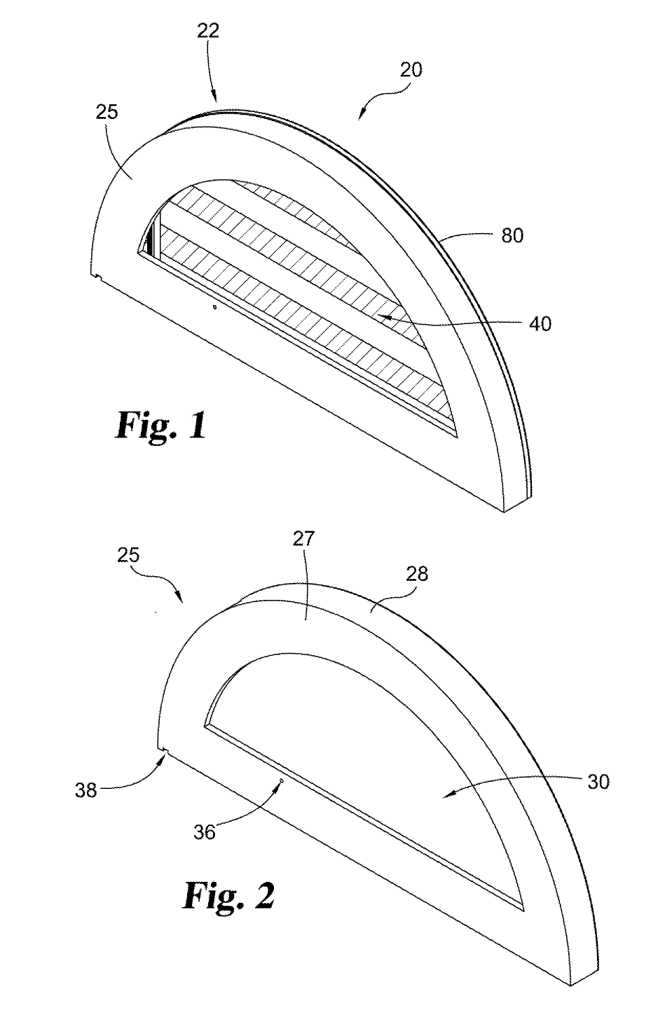

FIG. 1 illustrates a window covering assembly 20 including a housing 22 having a first portion 25 and a second portion 80. A movable panel assembly 40 is positioned in housing 22 between first portion 25 and second portion 80. Movable panel assembly 40 is movable relative to first portion 25 and/or second portion 80.

A perspective view of first portion 25 is shown in FIG. 2. First portion 25 includes a first wall 27 and a second wall 28 extending forwardly from, and transverse to, first wall 27. First portion 25 defines an opening 30 in first wall 27 that, when the assembly is mounted to a window, faces the window.

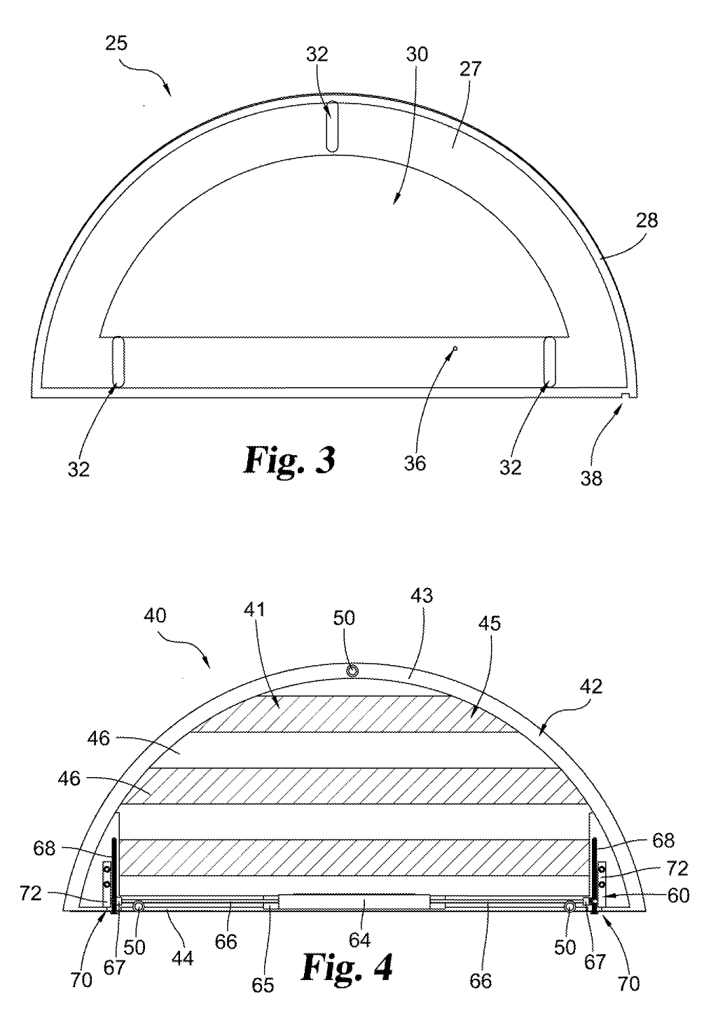

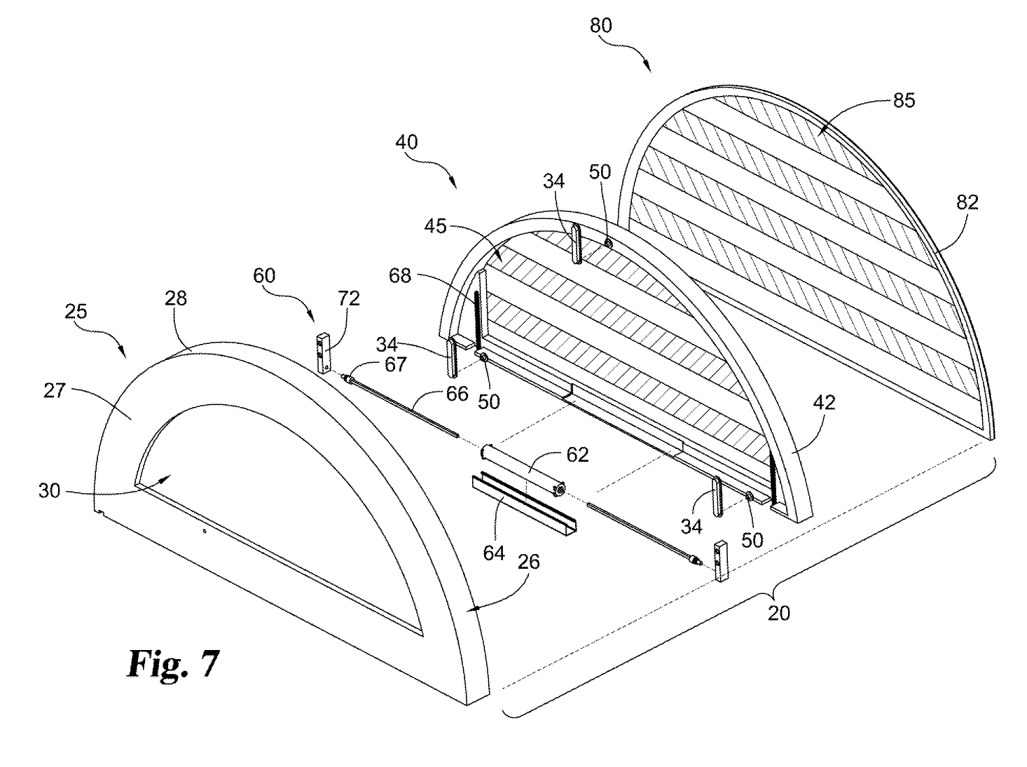

As shown in the front view of first portion 25 in FIG. 3, first wall 27 defines recesses 32. Recesses 32 are arranged to each receive a guide 34 (see FIG. 7) which in cooperation with pegs 50 maintains alignment of the movable panel assembly 40 relative to first portion 25 and/or limits movement movable panel assembly to translational movement relative to first portion 25.

First portion 25 defines a hole 36 for receiving a power cable. The power cable to the motor of the assembly (discussed below) may extend from a battery pack that is external to the assembly. When the assembly is positioned in a window, the battery pack may be positioned between the assembly and the pane and/or frame of the window. To allow access from the front of the assembly to charge the battery pack, first portion 25 may define a notch 38 arranged to receive a charging cable for the battery pack, the notch extending along a bottom surface of first portion 25.

A rear view of movable panel assembly 40 is illustrated in FIG. 4. Movable panel assembly 40 includes a frame 42 defining an opening 41. In many instances, frame 42 extends around the periphery of opening 41. Frame 42 can include an upper portion 43 and a lower portion 44. Upper portion 43 can define an arch corresponding to the shape of an arched window.

A panel 45 extends across opening 41 defined by frame 42. Panel 45 can be formed from a series of slats 46. Slats 46 may have varying degrees of opacity. As an example, one slat may be more opaque than an adjacent slat 46. Slats 46 do not have to be completely opaque or completely non-opaque, but may have varying degrees of opacity to allow adjustment of visible light as desired.

Movable panel assembly 40 can include pegs 50. Pegs 50 can be positioned on frame 42 to correspond with the position of recesses 32 in first portion 25 when frame 42 is brought into cooperation with first portion 25. Each peg 50 is sized to fit within a recess and/or a guide 34 that may be nested within recess 32.

When pegs 50 are received within guides 34, the translational movement of pegs 50 is limited to that along the vertical direction. As pegs 50 and guides 34 are spaced apart across movable panel assembly 40 and first portion 25, movement of movable panel assembly 40 is limited to translational movement and rotation of movable panel assembly 40 relative to the housing is resisted. Guides 34 may also, in some circumstances, provide an upper and/or lower limit on the distance movable panel assembly 40 may travel in the vertical direction.

A drive assembly 60 configured to move movable panel assembly 40 relative to the housing is mounted on lower portion 44 of frame 42. Drive assembly 60 includes a motor 62 (see FIG. 7) that is secured in a bracket 64. Bracket 64 and motor 62 are supported on lower portion 44 of frame 42. In some embodiments, bracket 64 is received within a recess 65 defined by lower portion 44.

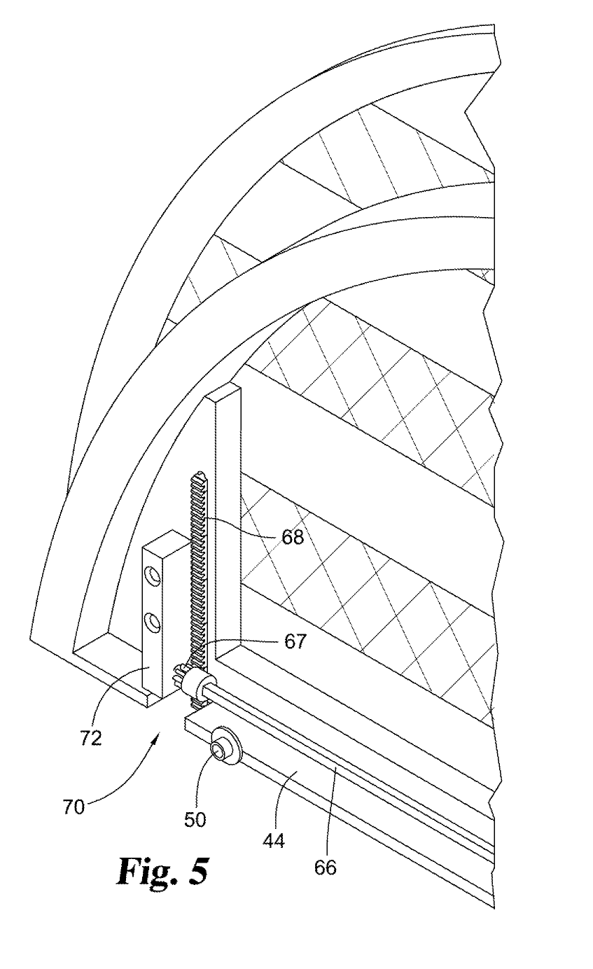

Extending from motor 62 is a driveshaft 66. Driveshaft 66 extends from each side of motor 62 toward an edge of frame 42. As shown in FIGS. 4 and 5, outer portions of drive shaft 66 include pinion gears 67 in communication with gear racks 68 to form a rack and pinion gear arrangement. Each gear rack 68 is aligned with a notch 70 defined through lower portion 44 of frame 42.

During operation, rotation of drive shaft 66 rotates pinion gear 67 to move the frame up the gear rack 68 (e.g., moving gear rack 68 downwardly through notch 70 relative to the frame). When movable panel assembly 40 is positioned in first portion 25 of housing, gear rack 68 engages the housing (e.g, engages second wall 28) to provide counterforce for movable panel assembly 40 to be moved upward.

Bushings 72 are positioned adjacent to gear racks 68 and support the ends of driveshaft 66, such as by an end of driveshaft 66 extending into an opening in bushing 72. Advantageously, this can reduce the bending force applied by the pinion gears and gear racks to the driveshaft. Additionally, the bushings can aid in keeping pinion gear 67 engaged with gear rack 68.

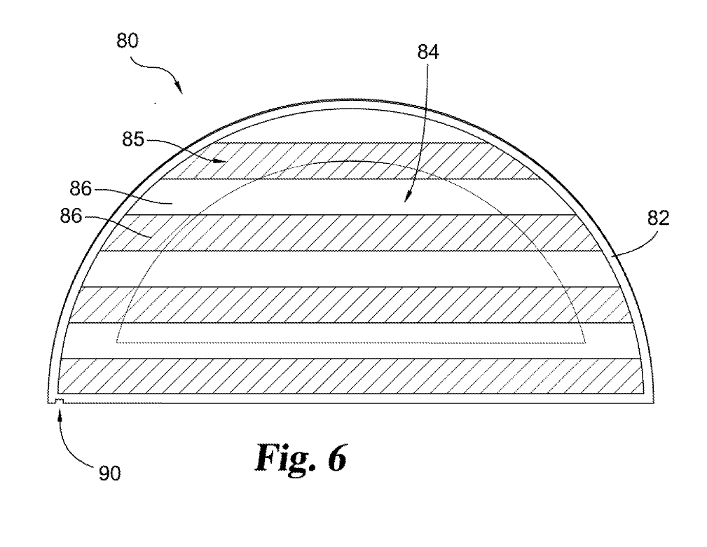

FIG. 6 illustrates a rear view of second portion 80 and a panel 85. Second portion 80 includes a frame 82 that defines an opening 84. When the assembly is attached to a window, opening 84 faces the window.

Panel 85 is attached to frame 82 and extends across opening 84. Panel 85 includes individual slats 86 and, similar to panel 45 on movable panel assembly 40, each slat 86 may having varying degrees of opacity, ranging from completely transparent to completely opaque. In some embodiments, the slats 86 may alternate so that one slat 86 is more opaque than an adjacent slat 86.

Frame 82 may also include a notch 90 that corresponds to the position of notch 38 in first portion 25.

An exploded view of assembly 20 is shown in FIG. 7. First portion 25 and second portion 80 fit together to enclose movable panel assembly 40. Each guide 34 fits within a respective recess 32 (see FIG. 3) in first portion 25. A corresponding peg 50 is received within each guide 34 to align movable panel 40 with first portion 25.

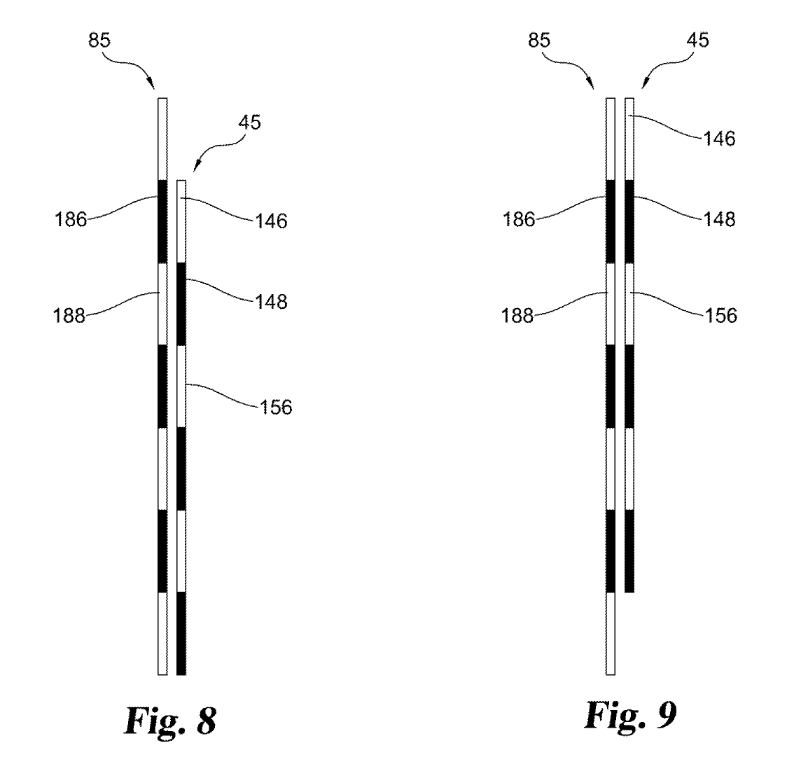

The amount of visible light allowed to pass through assembly 20 may be adjusted by moving panel 45 relative to panel 85. This movement alters the arrangement of the panels 45, 85 to change the alignment of slats. As an example, FIG. 8 illustrates slat 146 from the panel 45 aligned with slat 186 from the panel 85 and slat 148 of panel 45 aligned with slat 188 of panel 85. In this configuration, slat 146 is less opaque than slat 148 and slat 186 is more opaque than slat 188. The more-opaque slats from panel 45 are offset with those of panel 85 so that visible light is blocked from passing through the assembly along much of the height of the assembly 20. This configuration may be used when little to no visible light is desired to pass through the assembly.

FIG. 9 illustrates another configuration. In this configuration, movable panel assembly 40 has moved vertically with respect to second portion 80 so that the less-opaque slats from the panel 45 are aligned with the less-opaque slats from the panel 85 and the more-opaque slats from the panel 45 are aligned with the more-opaque slats from panel 85. This configuration may be used when visible light is desired to be allowed through assembly 10 as, in this arrangement, visible light is allowed through the portion of the assembly where the less-opaque slats 156, 188 of the panels 45, 85 are aligned.

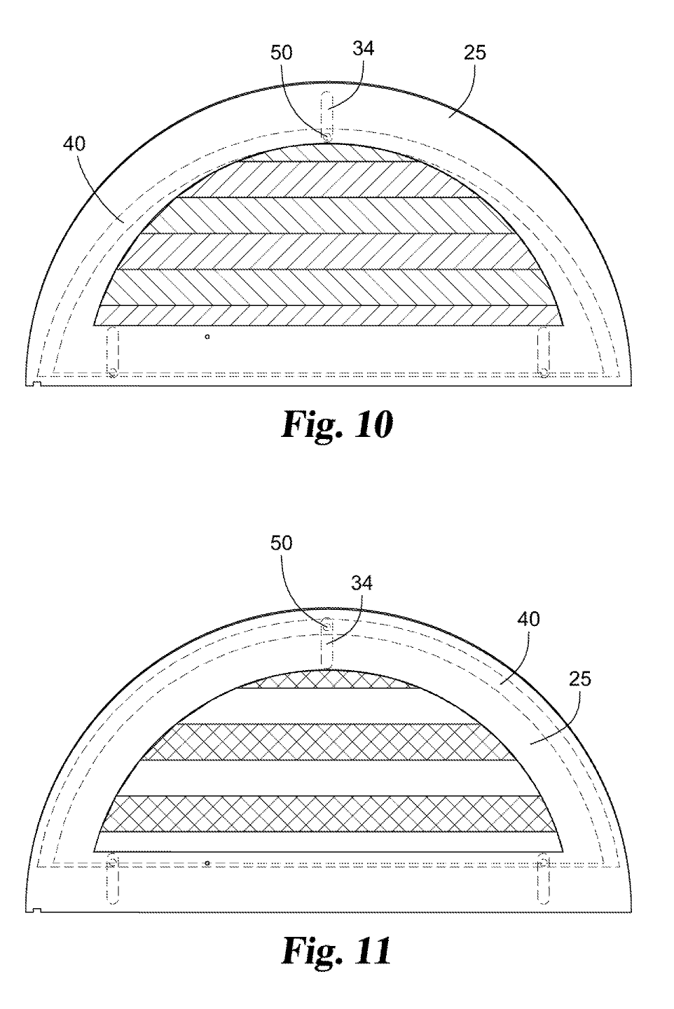

FIGS. 10-11 illustrate movement of movable panel assembly 40 with respect to first portion 25 and second portion 80 of the housing. FIG. 10 shows movable panel assembly 40 (in phantom) in a first position with respect to first portion 25 and second portion 80. In some embodiment, when movable panel assembly 40 is positioned in the position as shown in FIG. 10, the panels 45, 85 may be aligned as in FIG. 8 so that limited visible light is allowed to pass through assembly 10. In the position illustrated in FIG. 10, movable panel assembly 40 is positioned so that pegs 50 are near the bottom portion of the guides 34. In the position illustrated in FIG. 11, pegs 50 are near the top portion of guides 34. Advantageously, drive assembly 60 is hidden behind first wall 27 of first portion 25 through the entire range of movement of movable panel 40.

Movable panel assembly 40 may be moved with respect to second portion 80 by operating drive assembly 60. Motor 60 is activated to cause rotation of driveshaft 66 extending from motor 66. As driveshaft 66 rotates, the pinion gears 67 at the end of driveshaft 66 also rotate, engaging a respective gear rack 68. The rotation of pinion gears 67 moves the frame upward relative to the gear rack and the gear rack 68 downward relative to the frame. When the gear rack 68 is fixed relative to a portion of the housing, the movable panel assembly 40 moves linearly upward relative to the housing.

FIG. 11 shows movable panel assembly 40 (in phantom) in a different position with respect to first portion 25 and second portion 80. In this second position, movable panel assembly 40 is positioned so that each peg 50 is near the top portion of a respective guide 34. As an example, in this position, the panels 45, 85 may be aligned as shown in FIG. 8 so that visible light may pass through the portions of panels 45, 85 where non-opaque panels are aligned.

Movable panel assembly 40 may also be stopped at intermediate positions between a first position (e.g., FIG. 11) and a second position (e.g., FIG. 10). It is possible the individual slats 46, 86 will not completely align in these intermediate positions, allowing less visible light to pass through assembly 10 than when the less-opaque slats 46, 86 are completely aligned as shown in FIG. 9, but also not blocking as much visible light from passing through as when the more-opaque slats 46 are aligned with less-opaque slats 86 as shown in FIG. 8. A user may stop movable panel assembly 40 at any intermediate position as desired to adjust the amount of visible light that is allowed through assembly 20.

Movable panel assembly 40 moves in a transverse direction with respect to the orientation of slats 46 of panel 45 and slats 86 of panel 85. For example, in FIG. 10-11 the longitudinal direction of slats 46, 86 is substantially horizontal and movable panel assembly 40 is driven by drive assembly 60 to move vertically with respect to slats 46, 86. The transverse movement of movable panel assembly 40 allows variation of the alignment between slats 46 and slats 86. In some embodiments, the orientation of slats 46, 86 may vary. For example, slats 46, 86 may be arranged vertically, and movable panel assembly 40 may be configured to move horizontally. It is also contemplated that slats may be non-linear (e.g., zig-zag and/or curvilinear). It is preferable; however, that the slat arrangements of the first panel complement the slat arrangements of the second panel.

In the embodiment shown, panel 45 is smaller than panel 85; however, the size of panels 45, 85 may be varied. For example, panel 45 and panel 85 may be the same size or panel 45 may be larger than panel 85. In many instances, panel 45 is larger than opening 30 so that frame 42 is not visible from opening 30 before, during, and/or after movement of movable panel assembly 40 from a lowered position to a raised position and/or vice versa.

The heights of panel 45 and opening 30 can be correlated. For example, the height of panel 45 can be at least the height of opening 30 plus travel distance of the movable panel assembly (e.g., the height of a slat). Such an arrangement may aid in concealing frame 42 behind first portion 25 of the housing.

Different size slats 46, 86 and embodiments having varying slat size (e.g., different slat height) are envisioned. As will be appreciated by one skilled in the art, the slat height and the distance of travel of the movable panel assembly 40 can be correlated. For example, narrower alternating slats may require less vertical movement than wider slats in order to move opaque or non-opaque slats into alignment (as illustrated in FIG. 9) and/or into an alternating pattern (as illustrated in FIG. 8).

The following numbered clauses set out specific embodiments that may be useful in understanding the present invention:

1. A window covering assembly comprising:

a housing defining a first opening;

a first panel attached to the housing and extending across the first opening, the first panel having a first non-opaque portion;

a frame defining a second opening, the second opening facing the first opening;

a second panel attached to the frame and extending across the second opening, the second panel having a first non-opaque portion; and

a drive assembly coupled to the frame and configured to move the frame from a first position to a second position relative to the housing;

wherein in the first position the first non-opaque portion of the second panel is aligned with the first non-opaque portion of the first panel; and

wherein in the second position the first non-opaque portion of the second panel is offset from the first non-opaque portion of the first panel.

2. The window covering assembly of clause 1, wherein:

the drive assembly is configured to move the frame along a first direction; and

wherein the frame extends along an edge of the second panel in the first direction.

3. The window covering assembly of any preceding clause, wherein:

the frame defining the second opening extends around the perimeter of the second opening.

4. The window covering assembly of any preceding clause, wherein:

the drive assembly is arranged to move the frame translationally relative to the housing.

5. The window covering assembly of any preceding clause, wherein:

the frame is limited to translational movement relative to the housing.

6. The window covering assembly of any preceding clause, wherein:

the drive assembly includes a motor coupled to a bottom portion of the frame and arranged to push the frame upwards against the force of gravity.

7. The window covering assembly of clause 6, wherein:

the motor moves with the frame from the first position to the second position.

8. The window covering assembly of any preceding clause, wherein:

the frame is positioned within the housing.

9. The window covering assembly of any preceding clause, wherein:

the second panel includes at least two slats and wherein at least one of the slats is less-opaque than at least one of the other slats.

10. The window covering assembly of clause 9, wherein:

the first panel includes at least two slats and wherein at least one of the slats is less-opaque than at least one of the other slats.

11. The window covering assembly of clause 10, wherein:

the drive assembly includes a driveshaft extending from the motor and having a pinion gear engaging a gear rack, wherein the gear rack is movable relative to the frame.

12. The window covering assembly of any preceding clause, wherein:

the second panel is larger than the first opening.

13. The window covering assembly of any preceding clause, wherein:

an upper end of the housing is arched to correspond with an arched window.

14. A window covering assembly comprising:

a housing defining a first opening;

a first panel attached to the housing and extending across the first opening, the first panel having a first non-opaque portion; and

a second panel overlapping the first panel and coupled to a drive assembly configured to move the second panel from a first position to a second position relative to the first panel, the second panel having a first non-opaque portion;

wherein the drive assembly is arranged to push the second panel upwards against the force of gravity to move the second panel from the first position to the second position;

wherein in the first position the first non-opaque portion of the second panel is aligned with the first non-opaque portion of the first panel; and

wherein in the second position the first non-opaque portion of the second panel is offset from the first non-opaque portion of the first panel.

15. The window covering assembly of clause 14, wherein:

the drive assembly includes a motor that moves with the second panel from the first position to the second position.

16. The window covering assembly of clause 14 or 15, wherein:

the second panel is limited to translational movement relative to the first panel.

17. The window covering assembly of clause 14, 15, or 16, wherein:

the second panel is a different size than the first panel.

18. The window covering assembly of clause 17, wherein:

the second panel is larger than the first panel along the direction of movement from the first position to the second position.

19. The window covering assembly of any one of clauses 14-18, wherein:

an upper end of the housing is arched to correspond with an arched window.

20. The window covering assembly of any one of clauses 14-19, wherein:

the first panel includes at least two slats and wherein at least one of the slats is less-opaque than at least one of the other slats; and

the second panel includes at least two slats and wherein at least one of the slats is less-opaque than at least one of the other slats.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A window covering assembly comprising:
a housing defining a first opening;
a first panel attached to the housing and extending across the first opening, the first panel having a first non-opaque portion;
a frame defining a second opening, the second opening facing the first opening;
a second panel attached to the frame and extending across the second opening, the second panel having a first non-opaque portion; and
a drive assembly coupled to the frame and configured to move the frame from a first position to a second position relative to the housing;
wherein in the first position the first non-opaque portion of the second panel is aligned with the first non-opaque portion of the first panel; and
wherein in the second position the first non-opaque portion of the second panel is offset from the first non-opaque portion of the first panel.

2. The window covering assembly of claim 1, wherein:
the drive assembly is configured to move the frame along a first direction; and
wherein the frame extends along an edge of the second panel in the first direction.

3. The window covering assembly of claim 1, wherein:
the frame defining the second opening extends around the perimeter of the second opening.

4. The window covering assembly of claim 1, wherein:
the drive assembly is arranged to move the frame translationally relative to the housing.

5. The window covering assembly of claim 1, wherein:
the frame is limited to translational movement relative to the housing.

6. The window covering assembly of claim 1, wherein:
the drive assembly includes a motor coupled to a bottom portion of the frame and arranged to push the frame upwards against the force of gravity.

7. The window covering assembly of claim 6, wherein:
the motor moves with the frame from the first position to the second position.

8. The window covering assembly of claim 1, wherein:
the frame is positioned within the housing.

9. The window covering assembly of claim 1, wherein:
the second panel includes at least two slats and wherein at least one of the slats is less-opaque than at least one of the other slats.

10. The window covering assembly of claim 9, wherein:
the first panel includes at least two slats and wherein at least one of the slats is less-opaque than at least one of the other slats.

11. The window covering assembly of claim 10, wherein:
the drive assembly includes a driveshaft extending from the motor and having a pinion gear engaging a gear rack, wherein the gear rack is movable relative to the frame.

12. The window covering assembly of claim 1, wherein:
the second panel is larger than the first opening.

13. The window covering assembly of claim 1, wherein:
an upper end of the housing is arched to correspond with an arched window.

14. A window covering assembly comprising:
a housing defining a first opening;
a first panel attached to the housing and extending across the first opening, the first panel having a first non-opaque portion; and
a second panel overlapping the first panel and coupled to a drive assembly configured to move the second panel from a first position to a second position relative to the first panel, the second panel having a first non-opaque portion;
wherein the drive assembly is arranged to push the second panel upwards against the force of gravity to move the second panel from the first position to the second position;
wherein in the first position the first non-opaque portion of the second panel is aligned with the first non-opaque portion of the first panel; and
wherein in the second position the first non-opaque portion of the second panel is offset from the first non-opaque portion of the first panel.

15. The window covering assembly of claim 14, wherein:
the drive assembly includes a motor that moves with the second panel from the first position to the second position.

16. The window covering assembly of claim 14, wherein:
the second panel is limited to translational movement relative to the first panel.

17. The window covering assembly of claim 14, wherein:
the second panel is a different size than the first panel.

18. The window covering assembly of claim 17, wherein:
the second panel is larger than the first panel along the direction of movement from the first position to the second position.

19. The window covering assembly of claim 14, wherein:
an upper end of the housing is arched to correspond with an arched window.

20. The window covering assembly of claim 14, wherein:
the first panel includes at least two slats and wherein at least one of the slats is less-opaque than at least one of the other slats; and
the second panel includes at least two slats and wherein at least one of the slats is less-opaque than at least one of the other slats.
